(19) United States
(12) Patent Application Publication
(10) Pub. No.: US 2006/0088271 A1
(43) Pub. Date: Apr. 27, 2006

(54) Transient thermoelectric cooling of optoelectronic devices

(75) Inventor: Uttam Ghoshal, Austin, TX (US)

Correspondence Address: ZAGORIN O'BRIEN GRAHAM LLP, 7600B N. CAPITAL OF TEXAS HWY., SUITE 350, AUSTIN, TX, 78731, US

(73) Assignee: NanoCoolers, Inc.

(21) Appl. No.: 11/123,970

(22) Filed: May 6, 2005

Related U.S. Application Data
(60) Provisional application No. 60/621,382, filed on Oct. 22, 2004.
(60) Provisional application No. 60/673,956, filed on Apr. 22, 2005.

(51) Int. Cl. G02B 6/00

(52) U.S. Cl. 385/147

(57) ABSTRACT

A thermoelectric cooler may be transiently operated in substantial synchronization with operation of an optoelectronic device to provide extremely high density and intensity spot cooling when and where desired. The invented techniques described and illustrated herein can permit high luminous flux and/or longer lifetimes for a class of emissive device configurations and/or uses that generate intense highly localized, but transient heat flux. For example, certain Light Emitting Diode (LED) applications, e.g., white LEDs for flash illumination, certain solid state laser configurations and other similar configurations and uses may benefit from the developed techniques. In addition, the invented techniques described and illustrated herein can be employed in sensor configurations to provide greater device sensitivity. For example, in photosensitive device applications, e.g., CCD/CMOS imagers, the invented techniques may be employed to provide greater photon sensitivity and lower dark currents.

### CROSS-REFERENCE TO RELATED APPLICATION(S)

This application claims benefit of U.S. Provisional Application No. 60/621,382 entitled “TRANSIENT THERMOELECTRIC COOLING OF OPTOELECTRONIC DEVICES,” filed on Oct. 22, 2004.

In addition, this application is related to commonly-owned U.S. patent application Ser. No. ______, entitled “THERMOELECTRIC COOLING AND/OR MODERATION OF TRANSIENT THERMAL LOAD USING PHASE CHANGE MATERIAL,” naming Uttam Ghoshal as inventor and filed on even date herewith, the entirety of which is incorporated herein by reference.

### BACKGROUND

1. Field of the Invention

The present invention relates to transient cooling of optoelectronic devices, and particularly to transient use of thermoelectric cooling in synchrony with an operation of an optoelectronic device.

2. Related Art

Modern digital devices including consumer electronics increasingly employ optoelectronic devices. Digital cameras (as well as phones that include camera features) are good examples. Arrays of charge coupled devices (CCDs) or complementary metal oxide semiconductor (CMOS) sensors are used for image capture. In some devices, a flash may be employed, which may itself employ light emitting diodes (LEDs) or other technologies.

Individual elements of a CCD array convert energy from incoming light into electrons. The higher the intensity of incoming light (or the longer an element is exposed), the more free electrons an element accumulates. Of course, like most sensors, CCD's (and CMOS devices) are susceptible to noise because the materials and device structures exhibit a baseline level of electron “action” (or current). In sensors, this current is usually called dark current (the “dark” in the name implies that the current was formed without exposure to light). Dark current increases with temperature.

Sensitivity is typically limited by background noise. In general, smaller elements must tolerate higher noise for a given level of sensitivity. Accordingly, as higher and higher pixel densities are supported (often with smaller and smaller sensor elements), sensitivity and noise issues may become increasingly important. Efficient techniques for cooling arrays of optoelectronic sensors are therefore desired.

In addition to photosensitive devices, some photoemissive devices exhibit temperature sensitivity. For example, luminous flux and lifetime of white flash LEDs can be affected by operating temperatures. Most approaches to cooling flash LEDs and CCD have been limited to passive heat spreading packages. Unfortunately, it is difficult to increase the performance of white LEDs and CCDs with known passive methods. Alternative techniques are desired.

### SUMMARY

It has been discovered that a thermoelectric cooler may be transiently operated in substantial synchronization with operation of an optoelectronic device to provide extremely high density and intensity spot cooling when and where desired. The invented techniques described and illustrated herein can permit high luminous flux and/or longer lifetimes for a class of emissive device configurations and/or uses that generate intense highly localized, but transient heat flux. For example, certain Light Emitting Diode (LED) applications, e.g., white LEDs for flash illumination, certain solid state laser configurations and other similar configurations and uses may benefit from the developed techniques. In addition, the invented techniques described and illustrated herein can be employed in sensor configurations to provide greater device sensitivity. For example, in photosensitive device applications, e.g., CCD/CMOS imagers, the invented techniques may be employed to provide greater photon sensitivity and lower dark currents.

In some configurations, a thermoelectric cooler is employed in conjunction with phase change material. For example, the thermoelectric cooler may at least partially define a heat transfer path from the optoelectronic device to a body of phase change material. In such configurations, the phase change material may effectively clamp a hot-side temperature of the thermoelectric cooler during transient operation thereof, thereby lowering the delivered cold-side temperature thereof. The body of phase change material is sized to absorb into a phase transition thereof, at least a substantial portion of the heat transferred across the thermoelectric cooler. In some exploitations, the heat transfer results in the cooling of the optoelectronic device below an ambient temperature. In some exploitations, the substantial heat fluxes evolved by an optoelectronic device are absorbed into the phase transition. Alternatively, or additionally, a body of phase change material may at least partially define a heat transfer path from the optoelectronic device to the thermoelectric cooler. In some such configurations, the phase change material may be employed to absorb evolved thermal fluxes. In some such configurations, the phase change material may be pre-chilled (and typically pre-transitioned) as a result of transient operation of the thermoelectric cooler. These and other embodiments will be understood with reference to the description and claims that follow.

### BRIEF DESCRIPTION OF THE DRAWINGS

The present invention may be better understood, and its numerous objects, features, and advantages made apparent to those skilled in the art by referencing the accompanying drawings.

FIG. 1A depicts an illustrative configuration that includes both a photosensitive device and a photoemissive device, either or both of which may employ a body of phase change material in accordance with some embodiments of the present invention.

FIGS. 1B and 1C depict respective synchronization configurations that may be employed in conjunction with some device configurations that employ phase change material in accordance with embodiments of the present invention. In particular, FIGS. 1B and 1C depict respective synchronization configurations in which one or more synchronization circuits optionally coordinate readout or excitation of the photosensitive and photoemissive devices with operation of respective thermoelectric coolers.

FIG. 2 depicts an illustrative photoemissive device configuration in which a body of phase change material is employed in accordance with some embodiments of the present invention to clamp the hot side temperature of a thermoelectric.

FIG. 3 depicts related current and temperature profiles in an illustrative photoemissive device configuration, such as that illustrated in FIG. 2, in which a body of phase change material is employed in accordance with some embodiments of the present invention to clamp the hot side temperature of a thermoelectric.

FIG. 4 depicts an illustrative photosensitive device configuration in which a body of phase change material is employed in accordance with some embodiments of the present invention to clamp the hot side temperature of a thermoelectric.

FIG. 5 depicts an illustrative photoemissive device configuration in which a body of phase change material is employed in accordance with some embodiments of the present invention to absorb heat evolved by a photoemissive device during transient operation thereof and in which a thermoelectric is employed to cool the body of phase change material.

FIG. 6 depicts related current and temperature profiles in an illustrative photoemissive device configuration, such as that illustrated in FIG. 5, in which a body of phase change material is employed in accordance with some embodiments of the present invention to absorb heat evolved by a photoemissive device during transient operation thereof.

FIG. 7 depicts related current and temperature profiles in an illustrative photoemissive device configuration, such as that illustrated in FIG. 5, in which a body of phase change material is employed in accordance with some embodiments of the present invention to absorb heat evolved by a photoemissive device during transient operation thereof.

FIG. 8 depicts an illustrative photoemissive device configuration in which a body of phase change material is employed in accordance with some embodiments of the present invention to absorb heat evolved by a photoemissive device during transient operation thereof and thereby moderate temperature of the photoemissive device.

FIG. 9 depicts an illustrative cooling configuration for a photoemissive device employing a thermoelectric cooler and a body of phase change material.

FIG. 10 depicts an illustrative cooling configuration for a photoemissive device employing a thermoelectric cooler and a body of phase change material.

FIGS. 11A-11E show an embodiment of a module containing a body of phase change material in various stages of construction.

The use of the same reference symbols in different drawings indicates similar or identical items.

### DESCRIPTION OF THE PREFERRED EMBODIMENT(S)

While not limited thereto, the invented techniques described and illustrated herein can permit high luminous flux and greater lifetimes for flash LEDs, and greater photon sensitivity and lower dark currents for CCD/CMOS imagers. Accordingly, we describe aspects of the inventive concepts in the context of configurations, optoelectronic devices, materials and heat fluxes typical of consumer electronics such as digital cameras and mobile phones that incorporate similar technologies. However, as more completely described herein, the invention is not limited to such exploitations.

In particular, the description that follows emphasizes exploitations of the present invention in which a light emitting diode, e.g., a white LED, or other photoemissive device is used in a flash mode of operation, e.g., as flash illumination to support digital imaging. In such exploitations, extremely high transient thermal flux can be generated. Particularly for white LEDs, quality of the luminance, including intensity and in some cases spectral characteristics may be affected by operating temperature of the LED. Furthermore, useful operating life of such LEDs can be adversely affected by operation at high temperatures. In addition, in typical exploitations for small form factor electronics, such as digital cameras, phones, etc., thermal sensitivity of other optoelectronic devices, e.g., CCD or CMOS imagers, RF electronics, etc may be adversely affected by thermal issues related to operation of such an LED.

Sensitivity and therefore performance of certain photosensitive devices such as CCD or CMOS imagers is typically limited by thermal background noise. In general, smaller or faster responding elements must tolerate higher levels of noise for a given level of sensitivity. Accordingly, as higher and higher pixel densities are supported (often with smaller and smaller sensor elements), sensitivity and noise issues become increasingly important. Efficient techniques for cooling arrays of optoelectronic sensors are desirable. Since many CCD or CMOS imagers (e.g., those employed for image capture) are operated intermittently, rather than continuously, transiently applied cooling power can be advantageously employed as described herein.

For these and other reasons, cooling of a white LED flash illuminator to overcome a transient thermal load (or moderation thereof) and/or transient cooling of a CCD or CMOS imager serve as a useful descriptive context for certain inventive concepts and designs. However, based on the description persons of ordinary skill in the art will appreciate other exploitations of the described techniques. Accordingly, without limitation on the scope of inventive concepts described and claimed herein, we now describe certain exemplary embodiments.

General Techniques

In some, though not all, embodiments in accordance with the present invention, we exploit two basic technologies. First, we use transient cooling properties of thermoelectric coolers to get large cooling powers and temperature differentials. For example, in some embodiments, a thermoelectric cooler for an illuminator or imager is operated in a generally synchronous manner with flash illumination or image capture. Peltier cooling provided by a typical thermoelectric cooler is nearly instantaneous, but evolution of Joule heat and its subsequent back flow to a cold end of the thermoelectric element is comparatively slow. As a result, the cooling power transiently delivered can be much higher than steady-state performance would suggest.

Thermoelectric devices and materials are well-known in the art and a wide variety of configurations, systems and exploitations thereof will be appreciated by those skilled in the art. In general, exploitations include those in which a temperature difference is developed as a consequence of a current or electromotive force (typically voltage) across an appropriate material, material interface or quantum structure. Often, such exploitations operate based on the Peltier effect. Peltier effects arise at interfaces between dissimilar conductive (or semiconductive) materials. However, more generally, other effects or actions may be similarly exploited, including related or similar effects (e.g., Thomson, quantum tunneling and thermoionic effects) in materials, at material interfaces or as a result of quantum scale confinement.

Accordingly, for purposes of the present description, the term “thermoelectric cooler” is meant in the broadest sense of the term in which current or electromotive force is traded for temperature difference across a thermoelectric module, couple, element, device, material etc, and therefore includes those thermoelectric cooler configurations which exploit Peltier effects, as well as those that operate based upon Thomson, quantum tunneling, thermoionic or other similar effect or combination of effects. That said, for clarity of description, we focus on Peltier-type thermoelectric coolers; however, based on such description, persons of ordinary skill in the art will appreciate applications of the described inventive concepts to devices and configurations in which other thermoelectric-type effects are employed.

Second, we employ a phase-change material. Phase-change material may be positioned at either the hot-end or the cooled-end (or both the hot-end and the cooled-end) of a thermoelectric module, couple, element, device, material etc. When positioned at the hot-end, the phase-change material effectively clamps the hot side temperature of the thermoelectric as heat transferred across the thermoelectric is absorbed into the transition of at least some of the phase change material from a first state thereof to a second state. Because the thermoelectric nearly instantaneously develops a temperature differential between cooled and hot sides thereof, if the particular phase change material and amounts thereof are appropriately selected in relation to operating temperatures and expected thermal flux, virtually all of the temperature change will be delivered as cold-side cooling. Typically, the thermoelectric is transiently operated in substantial synchrony with operation of the photoemissive or photosensitive device to provide extremely high density spot cooling when and where desired.

When positioned at the cooled-end (i.e., when positioned thermally between the photoemissive device and the thermoelectric), the phase-change material can effectively absorb a large transient heat flux generated or evolved by a photoemissive device, thereby avoiding large localized excursions in temperature of the device that may otherwise occur when the heat flux generated or evolved overwhelms a conventional heat transfer pathway away from the photoemissive device. The thermoelectric then acts as part of a heat transfer pathway away from the phase-change material, eventually reversing the phase change into which the large transient heat flux was absorbed. Because of the large heat capacity represented by a phase change, the thermoelectric need not be operated simultaneously (in a transient mode) with operation of the photoemissive device. Rather, the thermoelectric may be operated continuously or semicontinuously, e.g., at low power levels. Alternatively the thermoelectric may be operated intermittently at times that need not precisely correspond to operation of the photoemissive device. In this way, peak power requirements may be reduced for a system that includes both the thermoelectric and the photoemissive device.

In general, a thermoelectric cooler may be advantageously employed when the heat rejection thermal resistance (Rₜₕ) of the cooled device (e.g., an optoelectronic device alone or in combination with an attendant body of phase change material) is less than the product of the thermodynamic efficiency of the cooler (ε) and the operating temperature (Tₛ) of the optoelectronic device divided by the total power dissipation of the optoelectronic device (Q). In the case of a continuously operated thermoelectric cooler, this relation can be expressed as:
Rₜₕ<εTₛ/Q (1)

For example, if ε=0.1 for thermoelectric devices with ZT=1, Tₛ=330 K (57° C.), and Q=1W, then thermoelectric cooling delivered by continuous operation of the thermoelectric will be beneficial if Rₜₕ<33 K/W.

In general, depending on the phase change material employed and on ambient conditions, embodiments that place phase change material at (in thermal communication with) a cooled-end of a thermoelectric may operate to restore the phase change material to a phase compatible with ambient conditions or may operate to pre-transition the phase change material to an appropriate phase state. For example, in some embodiments, a thermoelectric may operate to return (post photoemission) a liquid-phase phase change material to an ambient-stable, solid state. Furthermore, in some embodiments, a thermoelectric may operate to presolidify (prior to photoemission) an ambient-stable liquid-phase phase change material. In short, both post-chill and pre-chill realizations are possible.

Of course, in some exploitations, thermally decoupled amounts of phase-change material may be positioned at both ends of a thermoelectric, if desired. Similarly, a thermoelectric may be omitted in certain configurations wherein the large transient heat flux generated or evolved by a photoemissive device and absorbed by the phase-change material may be effectively dissipated using other active or passive mechanisms sufficient to reverse the phase-change prior to a next operation of the photoemissive device.

Although particular phase change materials and particular phase transitions can vary from exploitation to exploitation, solid-liquid phase transitions exhibited in low-melt point solders or gallium confined in a nickel cavity are typically suitable for many of the optoelectronic device cooling implementations described herein. In some embodiments, the phase-change material may include a dielectric thermal interface material. More generally, an endothermic phase transition (whether solid-liquid, liquid-gas, solid-gas or solid-solid) of other materials may be exploited as long as transition temperatures, latent heats of transition and thermal conductivities of the materials are suitable for the heat fluxes involved and suitable material confinement/compatibility techniques are available.

### EXEMPLARY EMBODIMENTS

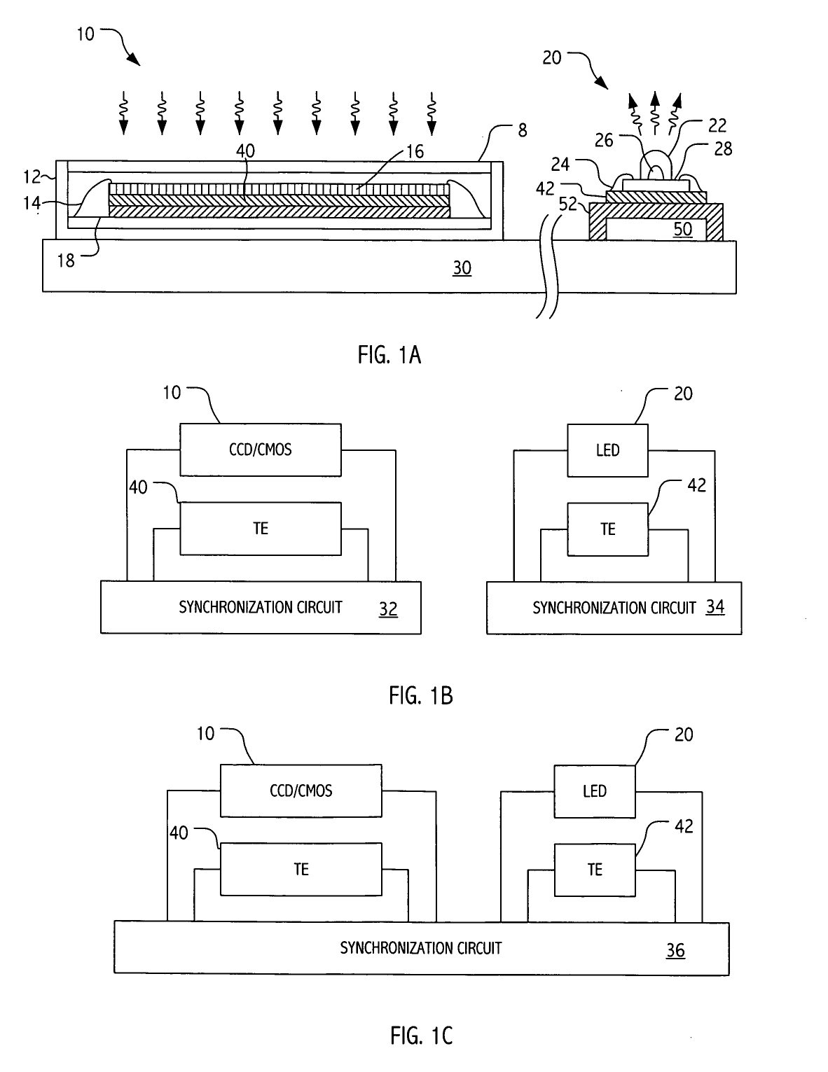

FIG. 1A depicts an illustrative configuration that includes two optoelectronic devices, a photosensitive device and a photoemissive device, either or both of which may employ a body of phase change material (PCM) in accordance with some embodiments of the present invention. As indicated by the arrows, photons pass through a screen 8 in the photosensitive device package 12 to impinge on a sensor device 16. The sensor device 16 is thermally coupled to the cold end of a thermoelectric cooler 40. The hot end of the thermoelectric cooler 40 may be coupled to a heat dissipating device (not shown) or mounted on the back plane 18 of the photosensitive device 10 as shown in the example. Electrical leads 14 provide a current path between the sensor device 16 and the back plane 18. The photosensitive device package 12 is then mounted on a printed wiring board 30. Although depicted as making contact to the back plane 18, electrical leads 14 may be wire bonded, flip-chip bonded, or surface mounted directly to the printed wiring board 30.

The photoemissive device 20 may be mounted on a separate board, or on the same printed wiring board 30, as shown in FIG. 1A. As indicated by the direction of the arrows emanating from the photoemissive device 20, photons are emitted through a transparent case 22 by the LED 26. Electrical leads 24 provide a current path between the LED 26 and a synchronization circuit. Although depicted as making contact to an intermediate plane, electrical leads 24 may be wire bonded, flip-chip bonded, or surface mounted directly to the printed wiring board 30. The base 28 of the LED 26 is thermally coupled to the cold end of a second thermoelectric cooler 42 The hot end of the second thermoelectric cooler 42 is thermally coupled to a phase change material 50, in this example by being thermally coupled to an encapsulant 52 confining the phase change material 50. Alternatively, the phase change material 50 could be confined by forming a region in which the surface tension of the phase change material 50 inhibits its flow when it is in a liquid state.

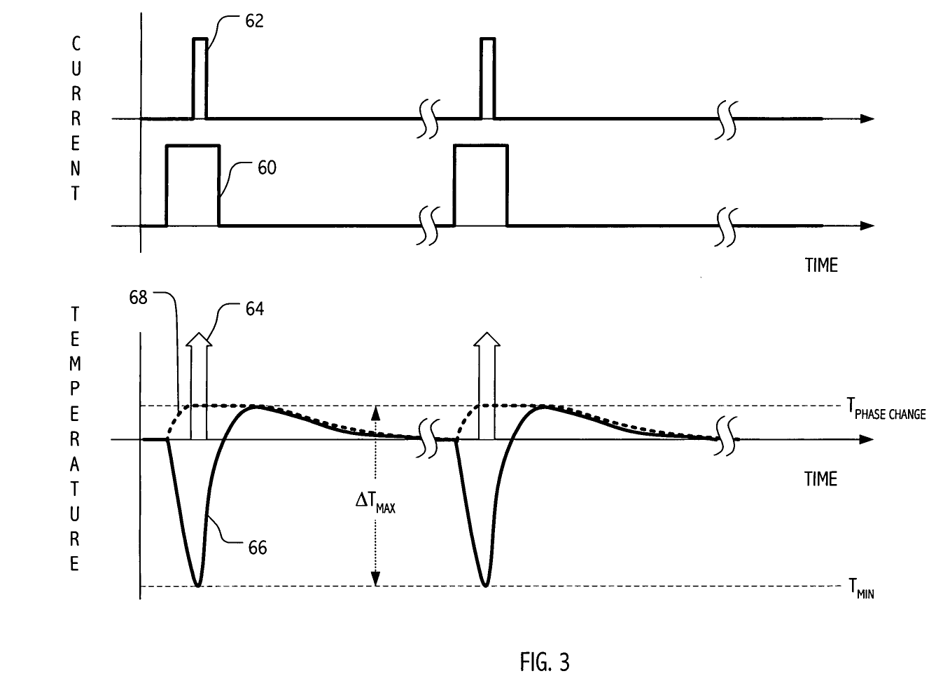

FIGS. 1B and 1C depict respective synchronization configurations that may be employed in conjunction with some device configurations that employ phase change material in accordance with embodiments of the present invention. In particular, FIGS. 1B and 1C depict respective synchronization configurations in which one or more synchronization circuits optionally coordinate readout or excitation of the photosensitive and photoemissive devices with operation of respective thermoelectric coolers. As shown in FIG. 1B, the photosensitive device 10, e.g., a CCD or CMOS array, and the first thermoelectric cooler 40 are driven by a first synchronization circuit 32, while the photoemissive device 20 and the second thermoelectric cooler 42 are driven by a separate synchronization circuit 34. Alternatively, as shown in FIG. 1C, the photosensitive device 10 and the first thermoelectric cooler 40 may be driven by the same synchronization circuit 36 as the photoemissive device 20 and the second thermoelectric cooler 42. As will be discussed in more detail below with reference to FIG. 3, the synchronization circuits 32, 34, and 36, may drive their respective devices substantially simultaneously or in other phase relationships.

In general, any of a wide variety of synchronization circuits or mechanisms may be employed. Suitable realizations of such synchronization circuits or mechanisms are typically application-specific and may constitute a matter of design choice. Indeed, suitable realizations of such synchronization circuits or mechanisms range from the sophisticated to the trivial. For example, many digital imaging exploitations in accordance with the present invention(s) may opportunistically exploit sophisticated programmable timing control facilities that may already be available to support the for the significantly more demanding timing requirements of shutter control, imager travel, auto focus processing, flash synchronization, etc. Alternatively, in some realizations, suitable synchronization may be provided simply as a byproduct of series or parallel coupling of current supply leads or paths for thermoelectric current and target device (e.g., LED) excitation. Based on the description herein and the design alternatives available to a given exploitation, persons of ordinary skill in the art will appreciate suitable synchronization circuits or mechanisms.

In general, selection of appropriate target devices (e.g., LEDs), associated driver circuits, package configurations etc. are matters of design choice and subject to numerous application-specific constraints and/or figures of merit that are largely independent of the thermoelectric and/or phase change material design factors described herein. Nonetheless, based on the description herein, persons of ordinary skill in the art will appreciate suitable selections and/or adaptations of their own configurations, parts or assemblies or those commercially-available now or in the future, to exploit techniques of the present invention. In this regard, LEDs available from various commercial sources, including Lumileds Lighting, U.S. LLC and Cree, Inc., are suitable for many exploitations. In general, devices and/or configurations that provide or allow a low thermal impedance path to a thermoelectric and/or phase change material are desirable. Unpackaged LED device or wafer configurations can offer flexibility in thermal design, though at the potential expense of additional packaging and test steps that could be avoided with use of a suitable packaged component. Selections of driver circuits may vary depending on a particular device selected.

Of course, commercial requirements and therefore suitable device selections are application-specific and may vary depending on the particular commercial exploitation. As a result, a person of skill in the art will typically consult manufacturer or supplier specifications or recommendations. In this regard, as of the filing date of this application, Lumileds Lighting, U.S. LLC provides (on it's website, www.lumileds.com) datasheets, reference design information and application briefs (including driver integrated circuit recommendations) and Cree, Inc. provides (on it's website, www.cree.com) specifications and application notes (including die attach recommendations) for their respective products.

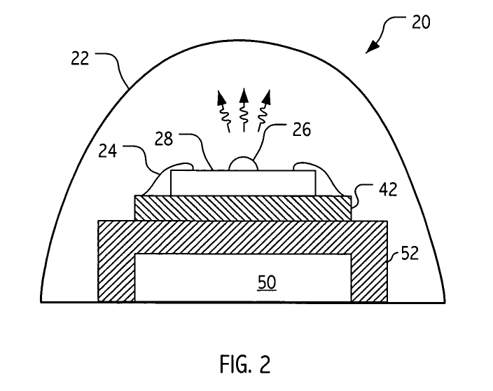

FIG. 2 depicts an illustrative photoemissive device configuration in which a body of phase change material is employed in accordance with some embodiments of the present invention to clamp the hot side temperature of a thermoelectric. Photons are emitted through a transparent case 22 by the LED 26. The transparent case 22 acts as a lens for the LED 26, providing a focusing function for the emitted light. While depicted as a traditional lens, it may also be a Fresnel lens, particularly when a flat, low-profile lens is desired. The base 28 of the LED 26 is thermally coupled to the cold end of a thermoelectric cooler 42. The hot end of the thermoelectric cooler 42 is thermally coupled to an encapsulant 52 confining a phase change material 50. Electrical leads 24 provide a current path between the LED 26 and a synchronization circuit. Although depicted as making contact to an intermediate plane, electrical leads 24 may be wire bonded, flip-chip bonded, or surface mounted directly to the printed wiring board 30. When the LED 26 emits light, heat is generated near the LED 26 by two mechanisms. First, current flowing through the LED 26 heats the device by Joule heating. Second, some photons are reflected by the transparent case 22, returning their energy to the LED 26 as heat in a process analogous to the greenhouse effect. This heat evolved by the operation of the photoemissive device 20 may degrade the future performance of the device if left unchecked. In this configuration, the thermoelectric cooler 42 defines part of a heat transfer path away from the photoemissive device 20. A substantial amount of the heat evolved during the transient operation of the photoemissive device 20 flows through the thermoelectric cooler 42 and into the phase change material 50 where it is absorbed. The operation of the cooling system to respond to this transient thermal load is now described with reference to FIG. 3.

FIG. 3 depicts related current and temperature profiles in an illustrative photoemissive device configuration, such as that illustrated in FIG. 2, in which a body of phase change material is employed in accordance with some embodiments of the present invention to clamp the hot side temperature of a thermoelectric device. The upper graph of FIG. 3 shows the temporal variation of current through the photoemissive device 20 and the thermoelectric cooler 42 of FIG. 2, while the lower graph shows the associated temperature variations in the system. A current pulse 60 is sent to the thermoelectric cooler 42 to develop a temperature differential between its hot and cold ends. Referring to the lower graph, the solid line shows that the temperature 66 of the cold end of the thermoelectric cooler 42 diverges from the temperature 68 of the hot end. When the temperature of the hot end reaches the phase transition temperature of the phase change material 50 (T_{PHASE CHANGE}), the phase change material 50 begins to undergo a phase transition from a first phase to a second phase. During this phase transition any heat absorbed by the phase change material 50, for example, heat transferred to it by thermal coupling to the hot end of the thermoelectric cooler 42 or evolved by the operation of the photoemissive device 20, acts only to change the phase of the material. There can be no temperature rise of the phase change material 50 above its phase transition temperature until all of the material has completed the transition. As seen in the graph, this effectively clamps the temperature of the hot end of the thermoelectric cooler 42 at T_{PHASE CHANGE}. Current continues to flow in the thermoelectric cooler 42, however, developing a greater temperature differential between the hot and cold ends of the device until the maximum temperature differential of the thermoelectric cooler 42, ΔT_{MAX}, is reached. With the temperature of the hot end clamped at T_{PHASE CHANGE}, the temperature of the cold end is reduced to T_{MIN}, below the ambient temperature.

Referring to the upper graph of FIG. 3, a second current pulse 62 is sent to the LED 26 to stimulate the emission of light (arrow 64 in the lower graph) at approximately the same time that the temperature of the cold end of the thermoelectric cooler 42 reaches T_{MIN}. As described above, the emission of light from the LED 26 evolves heat, which is transferred to the thermoelectric cooler 42, whose cold end is thermally coupled to the LED 26. This begins to raise the temperature of the cold end. When the first current pulse 60 to the thermoelectric cooler 42 stops, the temperature differential between its hot and cold ends falls as the temperature of the cold end rises as heat flows toward it from the hot end, which is still thermally coupled to the phase change material 50 at T_{PHASE CHANGE}. The lower graph shows that, as the system equilibrates, the temperature differential between the hot and cold ends of thermoelectric cooler 42 returns to zero, in this example when both ends reach T_{PHASE CHANGE}. At this point, no further heat is available to the phase change material 50 to continue its phase transition, which then stops. Both the phase change material 50 and the thermoelectric cooler 42 are at an elevated temperature relative to their surroundings, so heat continues to be transferred away from them. This reverses the phase transition. The reverse phase transition evolves heat, which is transferred away toward the lower-temperature parts of the system, clamping the temperature of the phase change material 50 (and so of the thermoelectric cooler 42) at T_{PHASE CHANGE} until the reverse phase transition is complete, returning the phase change material 50 to its original phase. After the reverse phase transition is complete, the temperature of the phase change material 50 (and so of the thermoelectric cooler 42) can fall below T_{PHASE CHANGE}, and the system continues to cool to its equilibrium temperature. The process can then be repeated as desired.

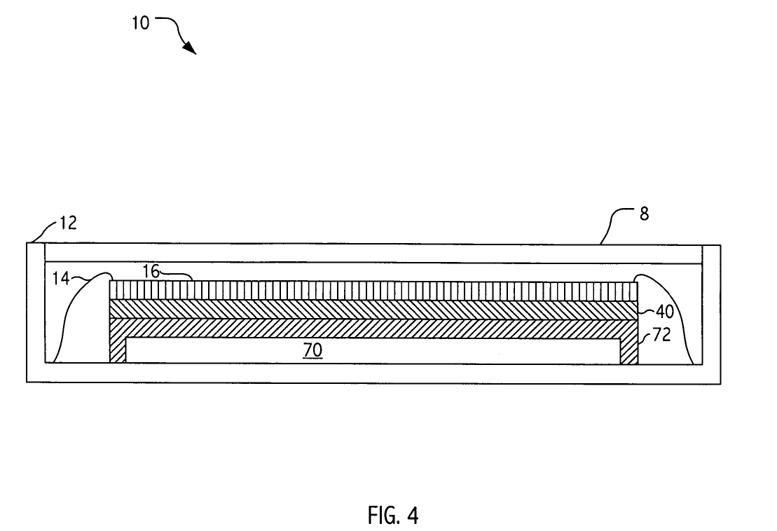

FIG. 4 depicts an illustrative photosensitive device configuration in which a body of phase change material is employed in accordance with some embodiments of the present invention to clamp the hot side temperature of a thermoelectric device. Photons pass through a screen 8 in the photosensitive device package 12 to impinge on a sensor device 16. Electrical leads 14 provide a current path between the sensor device 16 and the package 12. Although depicted as making contact to the back plane 18, electrical leads 14 may be wire bonded, flip-chip bonded, or surface mounted directly to the printed wiring board 30. The sensor device 16 is thermally coupled to the cold end of a thermoelectric cooler 40. The hot end of the thermoelectric cooler 40 is thermally coupled to an encapsulant 72 confining a phase change material 70. In this configuration, heat flows away from the optoelectronic device at least partially along a path defined by the thermoelectric cooler 40. Heat flows from the optoelectronic device through the thermoelectric cooler 40 to the phase change material 70, where a substantial amount of it is absorbed. The phase change material 70 clamps the temperature of the hot end of the thermoelectric cooler 40 at the phase transition temperature of the phase change material 70 as described above with reference to FIG. 3. Thus most of the temperature differential developed across the thermoelectric cooler 40 during operation will appear as a reduction in the temperature of the cold end of the thermoelectric cooler 40, which is thermally coupled to the sensor device 16.

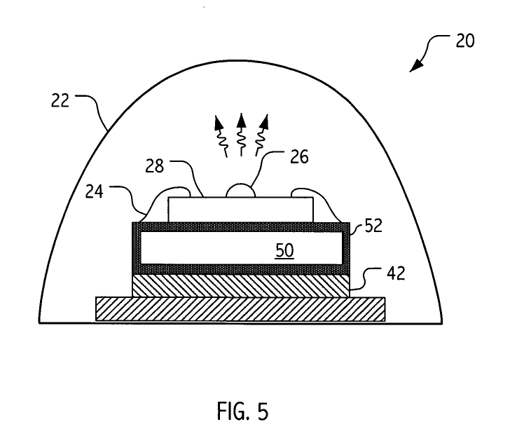

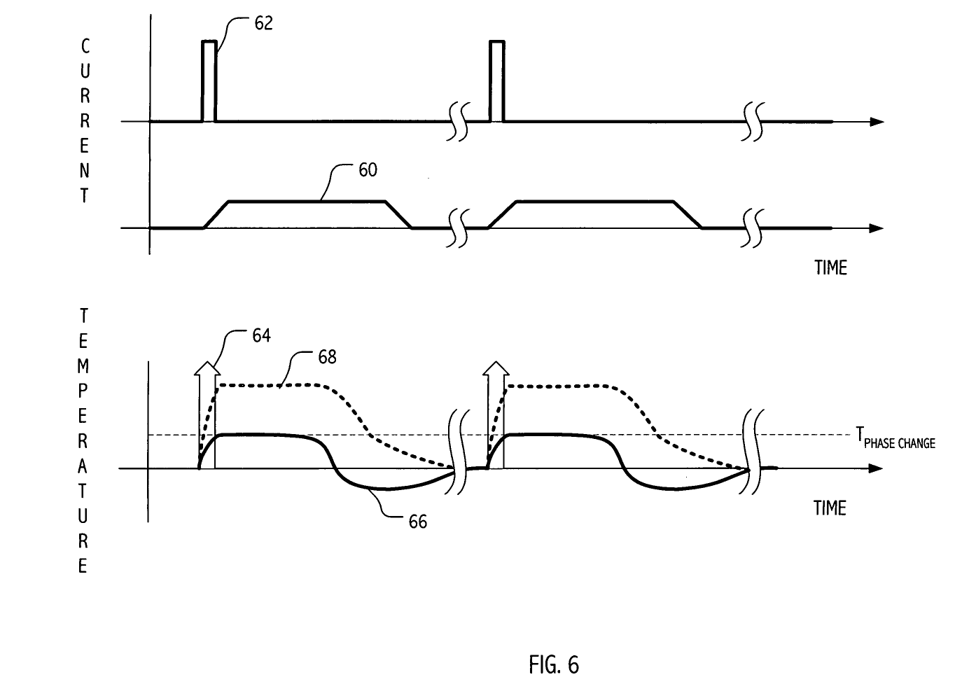

FIG. 5 depicts an illustrative photoemissive device configuration in which a body of phase change material is employed in accordance with some embodiments of the present invention to absorb heat evolved by a photoemissive device during transient operation thereof and in which a thermoelectric is employed to cool the body of phase change material. Photons are emitted through a transparent case 22 by the LED 26. The base 28 of the LED 26 is thermally coupled to an encapsulant 52 confining a phase change material 50, which is in turn thermally coupled to the cold end of a thermoelectric cooler 42. The hot end of the thermoelectric cooler 42 may be coupled to a heat dissipating device (not shown) or may transfer heat directly to its surroundings. Electrical leads 24 provide a current path between the LED 26 and a synchronization circuit. Although depicted as making contact to an intermediate plane, electrical leads 24 may be wire bonded, flip-chip bonded, or surface mounted directly to the printed wiring board 30. When the LED 26 emits light, heat is generated near the LED 26 as explained above with reference to FIG. 2. In this configuration, the thermoelectric cooler 42 defines part of a heat transfer path away from the phase change material 50. A substantial amount of the heat evolved during the transient operation of the photoemissive device 20 flows through the phase change material 50 where it is absorbed. As the transient heat load is removed, heat flows from the phase change material 50 into the thermoelectric cooler 42. The operation of the cooling system to respond to this transient thermal load is now described with reference to FIG. 6.

FIG. 6 depicts related current and temperature profiles in an illustrative photoemissive device configuration, such as that illustrated in FIG. 5, in which a body of phase change material is employed in accordance with some embodiments of the present invention to absorb heat evolved by a photoemissive device during transient operation thereof. The upper graph of FIG. 6 shows the temporal variation of current through the photoemissive device 20 and the thermoelectric cooler 42 of FIG. 5, while the lower graph shows the associated temperature variations in the system. A current pulse 62 is sent to the LED 26 to stimulate the emission of light (arrow 64 in the lower graph). The heat evolved during the operation of the LED 26 causes the temperature of the phase change material 50 to rise. As described above with reference to FIG. 3, when the temperature of the phase change material 50 reaches its phase transition temperature (T_{PHASE CHANGE}), the phase change material 50 begins to undergo a phase transition from a first phase to a second phase. At approximately the same time as the LED 26 flashes, a second current pulse 60 is sent to the thermoelectric cooler 42 to develop a temperature differential between its hot and cold ends. Referring to the lower graph, the solid line shows that the temperature 66 of the cold end of the thermoelectric cooler 42 diverges from the temperature 68 of the hot end. The temperature of the end of the thermoelectric cooler 42 thermally coupled to the phase change material 50, in this case the cold end, is clamped at T_{PHASE CHANGE} until the phase transition is complete, so most of the temperature differential developed across the thermoelectric cooler 42 during operation will appear as an increase in the temperature of the hot end of the thermoelectric cooler 42. Current continues to flow in the thermoelectric cooler 42, absorbing heat at the cold end and so from the phase change material 50. The endothermic phase transition stops and, as the operation of the thermoelectric cooler 42 transfers heat away from the phase change material 50, the phase transition reverses, evolving heat which is transferred to the thermoelectric cooler 42 through its cold end. After the reverse phase transition is complete, the temperature of the phase change material 50 (and so of the cold end of the thermoelectric cooler 42) can fall below T_{PHASE CHANGE}. With the temperature of the cold end of the thermoelectric cooler 42 no longer clamped and current flowing through the thermoelectric cooler 42, the full temperature differential between the hot and cold ends of the thermoelectric cooler 42 develops and the temperature of the cold end drops below ambient temperature. When the current pulse 60 to the thermoelectric cooler 42 stops, the temperature differential between its hot and cold ends falls, as the hot end cools and the temperature of the cold end rises to ambient temperature. After the system has returned to equilibrium, the process can be repeated.

FIG. 7 depicts related current and temperature profiles in another illustrative photoemissive device configuration, such as that illustrated in FIG. 5, in which a body of phase change material is employed in accordance with some embodiments of the present invention to absorb heat evolved by a photoemissive device during transient operation thereof. The upper graph of FIG. 7 shows the temporal variation of current through the photoemissive device 20 and the thermoelectric cooler 42 of FIG. 5, while the lower graph shows the associated temperature variations in the system. In this configuration, the ambient temperature is generally above the phase transition temperature (T_{PHASE CHANGE}) of the phase change material 50, so when the flash request is received, a current pulse 60 is sent to the thermoelectric cooler 42 to develop a temperature differential between its hot and cold ends to pre-chill phase change material 50 in anticipation of the operation of the photoemissive device (20 in FIG. 5). Referring to the lower graph, the solid line shows that the temperature 66 of the cold end of the thermoelectric cooler 42 diverges from the temperature 68 of the hot end. The temperature of the end of the thermoelectric cooler 42 thermally coupled to the phase change material 50, in this case the cold end, is clamped at T_{PHASE CHANGE} until the phase transition is complete. Current continues to flow in the thermoelectric cooler 42, absorbing heat at the cold end and so from the phase change material 50. When the cold end of the thermoelectric cooler 42 reaches the desired temperature, the current to the thermoelectric cooler 42 ceases and the temperature of the hot end of the thermoelectric cooler 42 begins to fall until it reaches the ambient temperature of the system. At approximately the same time, a current pulse 62 is sent to the LED 26 to stimulate the emission of light (arrow 64 in the lower graph). The heat evolved during the operation of the LED 26 is absorbed by the phase change material 50 causing its temperature to rise, first to its phase transition temperature and then, after completion of its endothermic phase transition, to the ambient temperature of the system. The temperature of the cold end of the thermoelectric cooler 42 tracks that of the phase change material 50, eventually returning to system ambient. The sequence may be repeated when the next flash request is received.

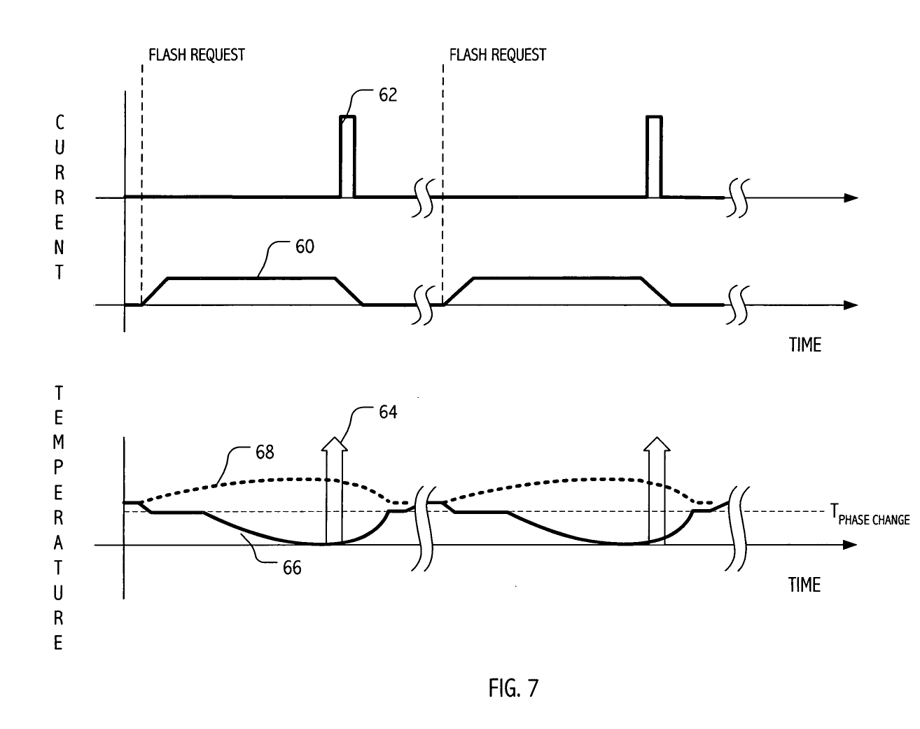

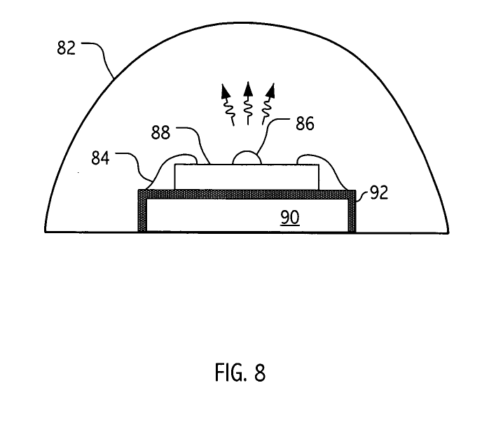

FIG. 8 depicts an illustrative photoemissive device configuration in which a body of phase change material is employed in accordance with some embodiments of the present invention to absorb heat evolved by a photoemissive device during transient operation thereof and thereby moderate the temperature of the photoemissive device. Photons are emitted through a transparent case 82 by the laser diode 86. Electrical leads 84 provide a current path between the laser diode 86 and a synchronization circuit. Although depicted as making contact to an intermediate plane, electrical leads 84 may be wire bonded, flip-chip bonded, or surface mounted directly to the printed wiring board 30. The base 88 of the laser diode 86 is thermally proximate to a phase change material 90, for example by being thermally coupled to an encapsulant 92 confining the phase change material 90. When the laser diode 86 emits light, heat is generated near the laser diode 86 as explained above with reference to FIGS. 2 and 5. The heat evolved during the operation of the laser diode 86 causes the temperature of the phase change material 90 to rise. As described above with reference to FIGS. 3 and 6, when the temperature of the phase change material 90 reaches its phase transition temperature (T_{PHASE CHANGE}), the phase change material 90 begins to undergo a phase transition from a first phase to a second phase. Until the phase transition is complete, the temperature of the laser diode 86 is clamped at T_{PHASE CHANGE}. As soon as the laser diode 86 stops emitting, no more heat is evolved and the phase transition slows and stops. The temperature of the phase change material 90 and the laser diode 86 thermally coupled thereto is elevated with respect to the surroundings, so heat is transferred away from the phase change material 90 until the reverse phase transition is initiated. Heat continues to be transferred away from the phase change material 90 until the reverse phase transition is completed, and the temperature of the phase change material 90, and so of the laser diode 86 thermally coupled thereto, returns to its equilibrium value, or ambient temperature.

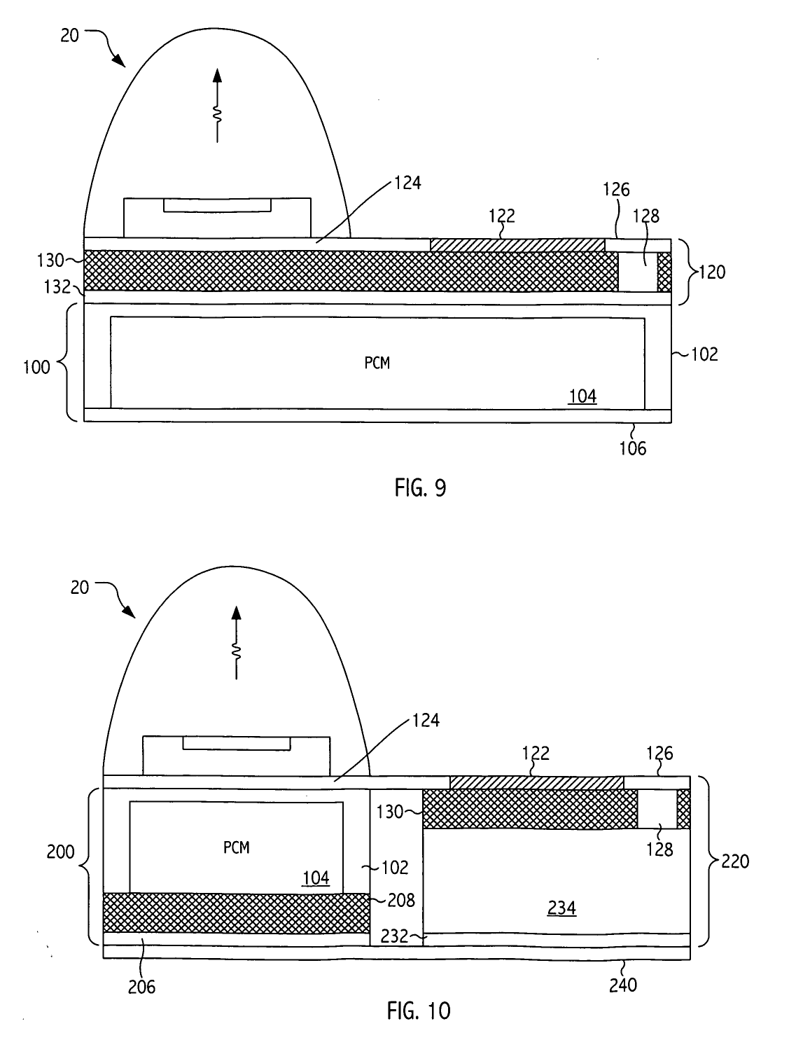

FIGS. 9 and 10 depict illustrative arrangements of thermoelectric coolers, phase change materials, and photoemissive devices. In FIG. 9, a phase change material (PCM) module 100 is formed by etching pits in a substrate 102, filling the pits (typically under vacuum to avoid inclusions) with the phase change material 104, and encapsulating the phase change material by depositing a layer of metal 106. Other suitable encapsulants include polytetrafluoroethylene (PTFE, marketed as Teflon® by DuPont, Wilmington, Del.) and related polymers, parylene, or layered structures of parylene and aerogel. “Parylene” is a generic term for a series of polymers based on para-xylylene and its substituted derivatives. Parylene N, or poly(para-xylylene), has a relatively higher melting point than parylene C, or poly(monochloro-para-xylylene), and parylene D, or poly(dichloro-para-xylylene). Parylene F, also called parylene AF-4, is poly(tetrafluoro-para-xylylene), and has a lower dielectric constant and higher thermal stability than parylene N. In general, such encapsulants can be employed, in configurations such as illustrated in FIG. 10, to provide thermal isolation and encapsulation that is tolerant to expansion (and contraction) of an encapsulated phase change material.

Referring to FIG. 9, the PCM module 100 is then bonded to the back side 132 of a thermoelectric cooler (TEC) assembly 120, making thermal contact to the hot side 126 of the TEC 122 via a thermally conducting plug 128 that passes through a layer of thermal insulation 130. A photoemissive device 20 is mounted on a thermally conducting pad 124 that is thermally coupled to the cold end of the TEC 122, shown here as a lateral thermoelectric cooler.

FIG. 10 shows a configuration in which a PCM module is in thermal contact with the cold end of the thermoelectric cooler. The PCM module 200 is formed by etching pits in a substrate 102, filling the pits with the phase change material 104, and encapsulating the phase change material by depositing a layer 208 of thermally insulating material, for example, PTFE, parylene, or layered structures of parylene and aerogel. A bonding layer 206 of metal is deposited on top of the thermal insulation. A layer 232 of metal is deposited on the back side of a second substrate 234 whose front side makes thermal contact to the hot side 126 of a TEC 122 via a thermally conducting plug 128 that passes through a layer of thermal insulation 130. The cold end of the TEC makes thermal contact with a cold pad 124, either by a joining operation or during initial fabrication of the TEC assembly 220, and the cold pad 124 is bonded to the PCM module 200. Both the TEC assembly 220 and the PCM module 200 are then mounted on a platform 240 for stability. A photoemissive device 20 can then be mounted on the thermally conducting pad 124.

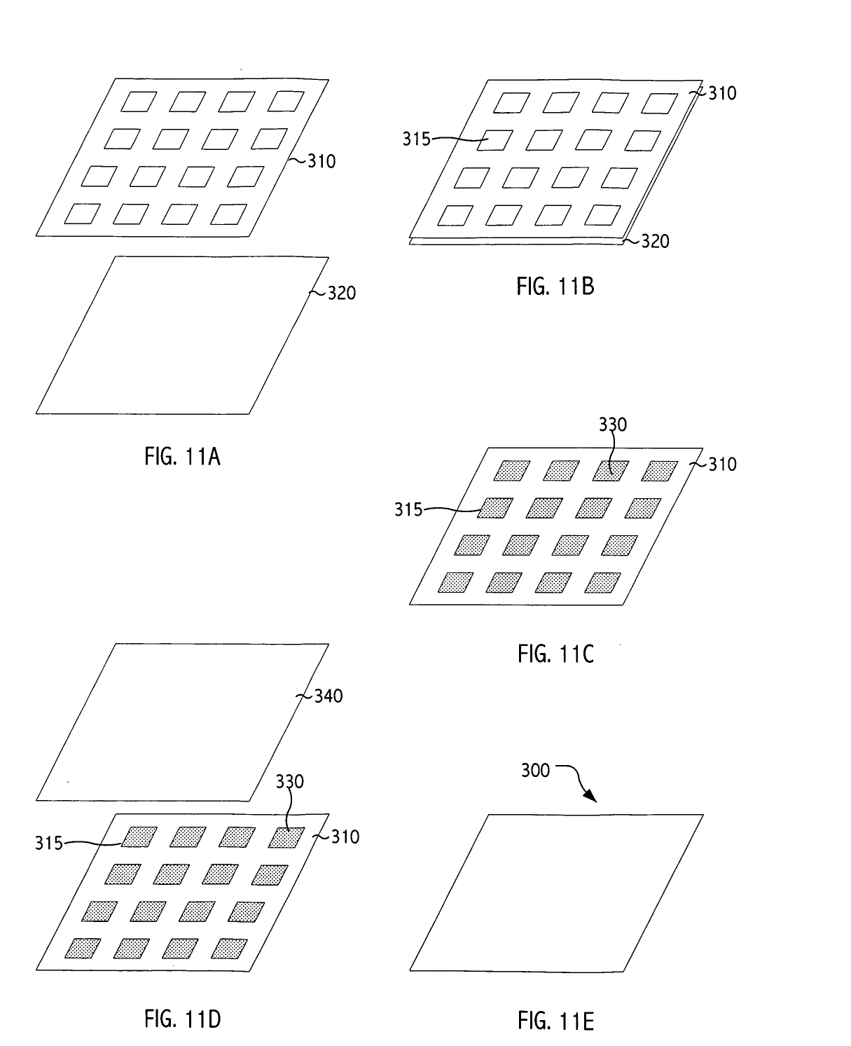

Another method of forming PCM modules is shown in FIGS. 11A-11E. A perforated foil 310 is placed atop a base foil 320 and bonded, forming wells 315. A phase change material 330 is added to the wells 315. It may be advantageous to fill the wells under vacuum to avoid the introduction of air. After the wells 315 have been filled they are covered by a top foil 340. The three foil layers 310, 320, and 340 are bonded together, sealing the phase change material 330 inside the PCM module 300.

Thermoelectrics, Generally

While embodiments of the present invention are not limited to any particular thermoelectric module or device configuration, certain illustrative configurations will be understood in the context of advanced thin-film thermoelectrics. Accordingly, merely for purposes of additional description and without limitation on the broad range of thermoelectric configurations that fall within the scope of any claim herein that recites a thermoelectric, thermoelectric element, thermoelectric device, thermoelectric structure, thermoelectric couple, thermoelectric module or the like, applicants hereby incorporate herein by reference the disclosure of commonly-owned U.S. patent application Ser. No. ______, entitled “LATERAL THERMOELECTRIC DEVICE STRUCTURE AND RELATED APPARATUS,” naming Ghoshal, Ngai, Samavedam and Miner as inventors, and filed on even date herewith.

Phase Change Materials, Generally

While virtually all materials undergo phase changes with temperature, so-called “phase change materials” or PCMs have transition temperatures in a range useful for a given application. For example, polymers and waxes that melt between 28° C. and 37° C. that are used in outdoor clothing to help maintain a comfortable temperature for the wearer may be used in certain exploitations. Pure elements, like gallium, and compounds, like water, exhibit sharp phase transitions, for example, melting at a precise temperature. Alloys and solutions, however, often complete the phase transition between liquid and solid states over a range of temperatures. An alloy containing 95% by weight of gallium and 5% indium begins to melt when heated above 15.7° C., its solidus temperature. As the alloy is heated further, liquid and solid phases coexist, and their compositions continually change, but the overall composition remains constant. When the alloy is heated to 25° C., all of the solid phase material has melted and the liquid alloy has a uniform composition. Eutectic compositions are alloy compositions whose solidus and liquidus temperatures are the same, so they behave like pure elements and have sharp melting points.

Relevant design properties of PCMs include the transition temperature range, the temperature range over which the PCM can be used, the latent heat of the transition, thermal conductivity, and thermal capacity, which is a measure of the energy that can be stored in the material over a given temperature range and which correlates with the material's density. In general, based on the description herein persons of ordinary skill in the art will be able to select an appropriate PCM for a given application. PCMs are commercially available from a number of sources. Major classes of PCM include waxes, polymers, hydrated salts, and liquid metals alloys. Table 1 illustrates several examples of PCMs, including examples from each major class.

Waxes are used primarily for lower-temperature applications. Wax compositions have been developed for an almost continuous distribution of transition temperatures. They typically have low densities and therefore low thermal capacities, but their light weight can be useful for some applications. Thermal conductivities are also low for waxes. Polymers typically exhibit poor thermal conductivity and low latent heats, but they are relatively easy to form and are compatible with many containment materials. Hydrated salts are more appropriate than waxes for higher temperature applications, but they, too, have low thermal conductivities. These inorganic salts are relatively inexpensive and are often used, for example, in first aid cold and hot packs.

Metals and alloys can be used at temperatures ranging from about −39° C., the melting point of mercury, to well over 200° C. Gallium melts at just under 30° C., the approximate operating temperature for many electronic devices. Metal PCMs typically have high thermal conductivities and large latent heats of fusion. In general, they are many times denser than other classes of PCM, contributing to higher heat storage capacities. Some alloys that are otherwise useful as PCMs contain elements that are not environmentally attractive, such as cadmium and lead. Nonetheless these alloys and even elemental Mercury may be suitable for some applications. In general, Gallium Indium alloys such as those illustrated in Table 1 provide an attractive combination of melt points, high thermal conductivities and large latent heats of fusion.

TABLE 1

| | Transition | | | |
|---|---|---|---|---|
| | Temperature | | | |
| Composition | liquidus | solidus | Densi | |
| (% by mass) | (° C.) | (° C.) | ty (g/cm³) | Class |
| Hg | −38.8^{†} | | 5.43 | metallic |
| 100 | | | | element |
| Ga/In/Sn | −7 | | | metal |
| 70/20/10 | | | | alloy |
| Paraffin 5 | 7 | | 0.86 | wax |
| ClimSel C 7 | 7 | | 1.42 | hydrated |
| | | | | salt |
| Ga/In/Sn/Zn | 7.6 | 6.5 | 6.5 | metal |
| 61/25/13/1 | | | | alloy |
| Ga/In/Sn | 10.7* | 10.7* | 6.5 | metal |
| 62.5/21.5/16 | | | | alloy |
| | | | | (eutectic) |
| Ga/In | 15.7* | 15.7* | 6.35 | metal |
| 75.5/24.5 | | | | alloy |
| | | | | (eutectic) |
| ClimSel C 24 | 24 | | 1.48 | hydrated |
| | | | | salt |
| Paraffin 26 | 25 | | 0.88 | wax |
| Ga/In | 25 | 15.7 | 6.15 | metal |
| 95/5 | | | | alloy |
| Ethylene/Vinyl Acetate | 27 | 47 | | copolymer |
| 60/40 | | | | |
| Ga | 29.8^{†} | | 5.9 | metallic |
| 100 | | | | element |
| ClimSel C 32 | 32 | | 1.45 | hydrated |
| | | | | salt |
| Ethylene/Vinyl Acetate | 41 | 63 | | copolymer |
| 68/32 | | | | |
| Bi/Pb/In/Sn/Cd/Hg | 43 | 38 | 9.28 | metal |
| 42.91/21.7/18.3/7.97/5/4 | | | | alloy |
| Bi/Pb/In/Sn/Cd | 47* | 47* | 9.16 | metal |
| 44.7/22.6/19.1/8.3/5 | | | | alloy |
| | | | | (eutectic) |
| ClimSel C 48 | 48 | | 1.36 | hydrated |
| | | | | salt |

*Eutectic compositions exhibit equal liquidus and solidus temperatures.
^{†}The transition temperature is the melting point of the element.

Generally, any of a variety of phase change materials may be employed in conjunction with the structures and configurations described herein. However, for at least some of the configurations illustrated herein, metals and metal alloys offer an attractive combination of properties and compatibilities with materials, temperatures and/or process technologies that may be employed in the forming, packaging and/or assembly of illustrated configurations. In general, phase change materials with phase transition points at or above an expected ambient temperature will be suitable for thermal moderation and for thermoelectric configurations that employ a body of the material at hot- or cooled-end of a thermoelectric. Phase change materials with transition points at or below an expected ambient temperature will generally be suitable for thermoelectric configurations that pre-chill a body of the material at a cooled-end of a thermoelectric.

In some realizations, a body of phase change material may include additional materials introduced to provide nucleation sites during phase transitions. In some realizations, a body of phase change material may compressible material or structures (e.g., small polystyrene balls or the like) to relieve stresses associated with expansion and contraction of the phase change material during phase transitions.

### OTHER EMBODIMENTS

While the invention(s) is(are) described with reference to various implementations and exploitations, it will be understood that these embodiments are illustrative and that the scope of the invention(s) is not limited to them. Many variations, modifications, additions, and improvements are possible. For example, while a variety of packaging configurations have been illustrated, exploitations of the present invention(s) need not correspond to any particular illustrated packaging of emissive, sensor or thermoelectric device. In general, packaging and other aspects of physical configuration are matters of design choice and may be conformed to application, commercially available device and/or market constraints as appropriate.

Plural instances may be provided for components, operations or structures described herein as a single instance. Finally, boundaries between various components and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. An apparatus comprising:
an optoelectronic device; and
a thermoelectric cooler thermally coupled to the optoelectronic device and operatively coupled to substantially synchronize a transient cooling operation of the thermoelectric cooler with an operation of the optoelectronic device.

2. The apparatus of claim 1, further comprising:
a synchronization circuit coupled to provide the substantial synchronization.

3. The apparatus of claim 1,
wherein the optoelectronic device and the thermoelectric cooler are electrically coupled in series such that a current flow therethrough powers and substantially synchronizes the transient cooling operation of the thermoelectric cooler with the optoelectronic device operation.

4. The apparatus of claim 1,
wherein the optoelectronic device and the thermoelectric cooler are electrically coupled in parallel such that related voltages applied thereto power and substantially synchronize the transient cooling operation of the thermoelectric cooler with the optoelectronic device operation.

5. The apparatus of claim 1, further comprising:
an array of optoelectronic devices including the optoelectronic device, the thermoelectric cooler thermally coupled to the array.

6. The apparatus of claim 1,
wherein the thermoelectric cooler is transiently operable to cool the optoelectronic device below an ambient temperature.

7. The apparatus of claim 1,
wherein the thermoelectric cooler is transiently operable to pre-chill the optoelectronic device and pre-transition a body of phase change material coupled thereto in anticipation of the synchronized with operation.

8. The apparatus of claim 1,
wherein the thermoelectric cooler is transiently operable to transfer thereacross heat evolved by the synchronized with operation of the optoelectronic device.

9. The apparatus of claim 1,
wherein the substantially synchronized transient cooling operation delivers cooling power to the optoelectronic device at least during the operation thereof.

10. The apparatus of claim 1,
wherein the substantially synchronized transient cooling operation delivers cooling power to the optoelectronic device prior to the operation thereof.

11. The apparatus of claim 1,
wherein the optoelectronic device includes a sensor device and wherein the synchronized with operation includes sampling a response of the sensor device to a photon flux.

12. The apparatus of claim 11, wherein the sensor device includes one or more of:
a charge coupled device (CCD); and
a complementary metal oxide semiconductor (CMOS) sensor.

13. The apparatus of claim 1,
wherein the optoelectronic device includes an emissive device.

14. The apparatus of claim 13,
wherein the synchronized with operation includes emission.

15. The apparatus of claim 13, wherein the synchronized with operation includes one or both of:
dissipation of a current through the emissive device; and
excitation of the emissive device.

16. The apparatus of claim 13, wherein the emissive device includes one or more of:
a light emitting diode (LED); and
a semiconductor laser.

17. The apparatus of claim 1, further comprising:
a body of phase change material that at least partially defines a heat transfer path from the optoelectronic device to the thermoelectric cooler.

18. The apparatus of claim 17,
wherein, as a result of the transient cooling operation of the thermoelectric cooler, at least a portion of the phase change material undergoes a transition from a first phase thereof to a second phase thereof.

19. The apparatus of claim 18,
wherein, as a result of an emissive operation of the optoelectronic device, at least a portion of the phase change material undergoes a transition from the second phase thereof to the first phase thereof.

20. The apparatus of claim 19,
wherein the phase change material undergoing the second-to-first phase transition absorbs a substantial portion of heat evolved by the emissive operation of the optoelectronic device.

21. The apparatus of claim 19,
wherein the transient cooling operation at least partially precedes the emissive operation.

22. The apparatus of claim 19,
wherein the transient cooling operation at least partially follows the emissive operation.

23. The apparatus of claim 1, further comprising:
a body of phase change material, wherein the thermoelectric cooler at least partially defines a heat transfer path from the optoelectronic device to the phase change material.

24. The apparatus of claim 23,
wherein, during transient operation of the thermoelectric cooler, temperature of a phase change material facing side of the thermoelectric cooler is substantially clamped based on a latent heat of transformation for the phase change material.

25. The apparatus of claim 23,
wherein, during transient operation of the thermoelectric cooler, at least a portion of the phase change material undergoes a transition from a first phase thereof to a second phase thereof.

26. The apparatus of claim 25,
wherein the phase change material undergoing the transition absorbs a substantial portion of heat transferred across the thermoelectric cooler during the transient operation thereof.

27. The apparatus of claim 25,
wherein the phase change material undergoing the transition absorbs a substantial portion of heat evolved by the synchronized with operation of the optoelectronic device.

28. A method comprising:
transiently cooling an optoelectronic device using a thermoelectric cooler thermally coupled thereto; and
substantially synchronizing the transient cooling with an operation of the optoelectronic device.

29. The method of claim 28, further comprising:
performing the transient cooling at least during the synchronized with operation of the optoelectronic device.

30. The method of claim 28, further comprising:
performing the transient cooling at least partially prior to an emissive or sampling operation of the optoelectronic device.

31. The method of claim 28,
wherein the optoelectronic device includes a sensor device; and
wherein the substantially synchronized operation includes sampling a response of the sensor device to photon flux.

32. The method of claim 28,
wherein the transient cooling reduces temperature of the optoelectronic device below an ambient temperature

33. The method of claim 28,
wherein the optoelectronic device includes an emissive device; and
wherein the substantially synchronized operation of the emissive device evolves heat.

34. The method of claim 33, further comprising:
transferring a substantial portion of the evolved heat across the thermoelectric cooler during the transient cooling.

35. The method of claim 28, further comprising:
substantially clamping temperature of one side of the thermoelectric cooler based on a latent heat of transformation of phase change material thermally coupled thereto.

36. The method of claim 28, further comprising:
absorbing into a transformation of phase change material, a substantial portion of heat transferred across the thermoelectric cooler during the transient operation thereof.

37. The method of claim 28, further comprising:
absorbing into a transformation of phase change material, a substantial portion of heat evolved by the substantially synchronized operation of the optoelectronic device.

38. The method of claim 28, further comprising:
pre-transforming, prior to the synchronized with operation, a body of phase change material.

39. An apparatus comprising,
an optoelectronic device;
a thermoelectric cooler thermally coupled to the optoelectronic device; and
a synchronization circuit coupled to substantially synchronize a transient cooling operation of the thermoelectric cooler with an operation of the apparatus.

40. The apparatus of claim 39,
wherein the synchronized with operation includes an emissive operation of the optoelectronic device.

41. The apparatus of claim 39,
wherein the synchronized with operation includes a sampling operation of the optoelectronic device.

42. The apparatus of claim 39,
wherein the transient cooling operation at least partially precedes an emissive or sampling operation of the optoelectronic device; and
wherein the synchronized with operation triggers a ready to sample or emit state of the optoelectronic device.

43. The method comprising:
transiently cooling an optoelectronic device using a thermoelectric cooler; and
wherein the transient cooling is performed at least partially prior to, and in anticipation of, an operation of the optoelectronic device.

44. The method of claim 43, further comprising:
in connection with the transient cooling, pre-transitioning phase change material thermally coupled to the optoelectronic device from a first phase thereof to a second phase thereof.

45. The method of claim 43, further comprising:
substantially synchronizing the transiently cooling with an operation that triggers a ready to sample or emit state of the optoelectronic device.

46. A method of making an imaging product, the method comprising:
thermally coupling a thermoelectric cooler to an optoelectronic device; and
coupling a synchronization circuit to at least one of the optoelectronic device and the thermoelectric cooler to substantially synchronize a transient cooling operation of the thermoelectric cooler with an operation of the optoelectronic device.

47. The method of claim 46, further comprising:
coupling the synchronization circuit to the other of the optoelectronic device and the thermoelectric cooler.

48. The method of claim 46, wherein the optoelectronic device includes one of:
a charge coupled device (CCD);
a complementary metal oxide semiconductor (CMOS) array;
a light emitting diode; and
a semiconductor laser.

49. The method of claim 46,
wherein a body of phase change material is thermally coupled to the thermoelectric cooler such that, after the thermoelectric cooler is thermally coupled to the optoelectronic device, the thermoelectric cooler at least partially defines, during operation thereof, a heat transfer path from the optoelectronic device to the phase change material.

50. The method of claim 46, further comprising:
thermally coupling a body of phase change material to the thermoelectric cooler such that, during operation of the thermoelectric cooler, temperature of a hot-side thereof is substantially clamped at a phase change temperature of the phase change material.

51. The method of claim 46, further comprising:
packaging the imaging product as a digital camera.
